(19) United States
(12) Patent Application Publication
(10) Pub. No.: US 2002/0029159 A1
(43) Pub. Date: Mar. 7, 2002

(54) System and method for providing an automated interview

(76) Inventor: David Robert Longden, Orillia (CA)

Correspondence Address: FASKEN MARTINEAU DUMOULIN LLP, Toronto Dominion Bank Tower, Box 20, Suite 4200, Toronto-Dominion Centre, Toronto, ON, M5K 1N6, CA

(21) Appl. No.: 09/885,525

(22) Filed: Jun. 21, 2001

(30) Foreign Application Priority Data
Sep. 6, 2000 (CA) 2,317,786

(51) Int. Cl. G06F 17/60

(52) U.S. Cl. 705/7

(57) ABSTRACT

A system provides a plurality of secondary users with an interview. The system comprises a questionnaire provided by a primary user, wherein the questionnaire includes a plurality of questions. A predefined weighting function is associated with the questions. The system further comprises a server operatively coupled with the secondary users for providing the questionnaire to the plurality of secondary users for performing the interview. A memory is associated with the server for storing results of the interview. The system further comprises a processor associated with the server for applying the predefined weighting function to the results of the interview for calculating a secondary user score, wherein if the secondary user score meets predefined criteria the secondary user proceeds to a second interview stage.

The field of the invention relates to an automated system for assisting a primary user interview a plurality of secondary users.

### BACKGROUND OF THE INVENTION

The proliferation of the Internet has provided a world-wide global community making it easier for individuals to locate information they desire, One form of such information on the Internet is the creation of an on-line employment community. Companies from around the world can post their job openings on the Internet, allowing them to attract potential job candidates from other countries. This feature allows companies to appeal to a global community thereby attracting applications from a wider number of job candidates.

However, although a company may benefit from attracting a larger number of applicants, the increased number of applicants requires an increased demand of human resources staff. Typically, for each applicant someone has to review the applicant's resume, determine whether or not an interview is desired, contact the applicant, and conduct the interview. Furthermore, in most circumstances the interview is typically not a single interview but rather a series of interviews conducted by various people. Generally, the first interview is performed for detecting and rejecting individual candidates that may have impressive resumes, but do not actually have the skills desired by an employer.

Therefore, there is a need for an automated system that assists in the interviewing process, thereby reducing the time and the cost of the hiring process. It is an object of the present invention to obviate or mitigate at least some of the above mentioned disadvantages.

### SUMMARY OF THE INVENTION

In accordance with the present invention there is provided a system for providing a plurality of secondary users with an interview. The system comprises a questionnaire provided by a primary user, wherein the questionnaire includes a plurality of questions. A predefined weighting function is associated with the questions. The system further comprises a server operatively coupled with the secondary users for providing the questionnaire to the plurality of secondary users for performing the interview. A memory is associated with the server for storing results of the interview. The system further comprises a processor associated with the server for applying the predefined weighting function to the results of the interview for calculating a secondary user score, wherein if the secondary user score meets predefined criteria the secondary user proceeds to a second interview stage.

In accordance with yet another aspect of the invention there is provided a system for providing a plurality of tertiary users with an interview. The system comprises a questionnaire including a plurality of questions provided by a primary user. A plurality of personal identification numbers (PINs) are associated with selective ones of a plurality of secondary users for identifying the secondary users. The system further includes a server operatively coupled with said secondary users. The server provides the questionnaire for performing the interview, wherein the tertiary user is connected with the interview via the secondary user. The system further includes a memory associated with the server for storing results of the interview and a processor associated with said server for selecting ones of said plurality of questions in accordance with said PIN. The selected questions are associated with said secondary user.

### BRIEF DESCRIPTION OF THE DRAWINGS

An embodiment of the present invention will now be described by way of example only with reference to the following drawings in which:

FIG. 1 is a schematic drawing of a system for providing an automated interview;

FIG. 2 is block drawing of a exemplary web page questionnaire.

### DETAILED DESCRIPTION OF THE PREFERRED EMBODIMENT

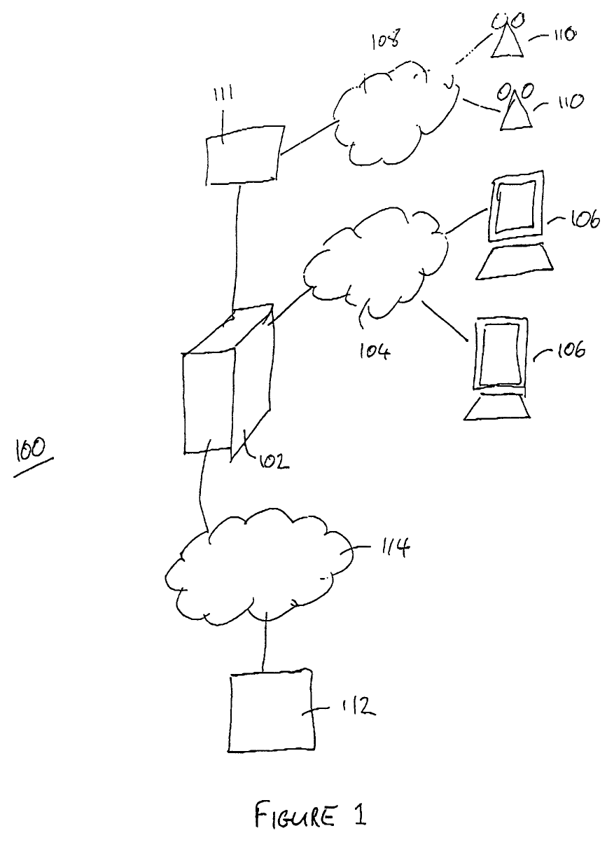

In the following description like numerals refer to like structures in the drawings. Referring to FIG. 1, a system for providing an automated interview is shown generally by the numeral 100. A server 102 is coupled via a first network 104 to a plurality of recipient's computers 106. The server 102 is further coupled via a second network 108 to a plurality of applicant telephones 110. The server 102 includes an integrated voice response (IVR) 111 for coupling the plurality of applicant telephones 10 with the server 102. The server 102 is still further coupled via a third network 114 to an employer 112. For the purpose of the following description, the first network 104 is the Internet, the second network 108 is a public switched telephone network (PSTN) and the third network is a local area network (LAN). However, the three networks may actually be the same (for example, the Internet). Further alternate network connections will be apparent to a person skilled in the art.

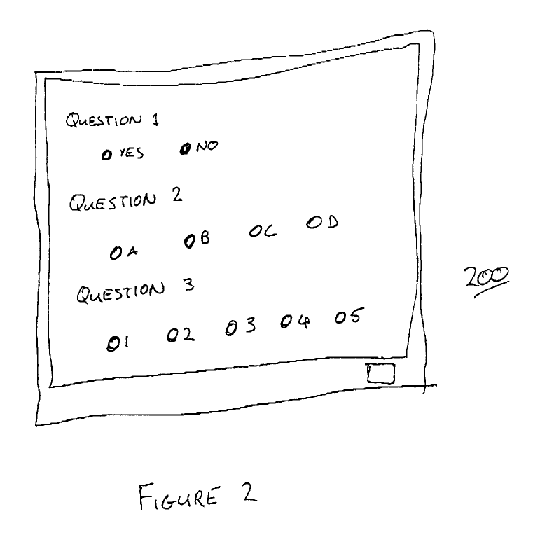

The server 102 hosts a web site. Referring to FIG. 2, an example of a web page on the web site hosted by the server 102 is shown generally by the numeral 200. The web page includes a list of questions for a potential job applicant to answer. Generally, the questions require an answer in a predefined form, such as “yes” or “no”, “select one of the following”, and “rate the following on a scale of 1 to 10”. The job applicant selects an appropriate answer by selecting an appropriate radio button. Alternately, list boxes, drop down list boxes, check boxes and the like may be used for selecting an answer. Furthermore, the questions may also require answers in the form of phrases or paragraphs. The web page also queries the individual for personal information such as the user's name, a method of contacting the individual such as email, address, telephone number, and the like.

The server applies a weighting function to the responses received by each of the potential job applicants for calculating a score in realtime. Alternately, the system can wait until the closing date has past and the web page and phone number for the IVR has been disabled before applying the weighting function to each of the questionnaires.

The weighting function is determined by predetermined criteria selected by the employer. The employer determines which of the questions posed to the applicants are more relevant for the position available. For example, for a sales position, the employer would typically be more interested in the job applicant's personal and communication skills than in the job applicant's technical skills. Therefore, the questions relating to personality and communication would be more heavily weighted than the remaining question. However, technical skills may also be important and therefore questions relating to technical skills may be weighted less than the personal and communication questions but greater than the remaining questions. Thus, the employer can customise the weighting of the questionnaire according to the position available.

The employer defines a range of scores for proceeding to a following interview stage. For example, the employer might define a range including only the top ten percent of all the applicants. Therefore, only those applicants whose weighted scores are among the top ten percent of the scores of all the job applicants are contacted to proceed to the following interview stage.

Alternately, the employer can determine a threshold score, above which all applicants are accepted. Therefore, for example, if the job applicant completes the questionnaire and the weighted answers correspond to a score that is higher than the predetermined threshold, the job applicant will be contacted to proceed to the following interview phase. Using this method the job applicant does not need to wait until a predetermined date to ascertain whether or not he/she will proceed to the following interview stage. All that is required is that that they meet a predetermined threshold score. Therefore, the server can calculate the weighted results of the questionnaire and provide the results to the applicant almost immediately after completing the questionnaire. Typically, the answers to the questionnaire are saved on the server for later use.

Yet alternately, the system can employ a selection process that is a hybrid of defining a threshold and defined a range of scores. Such variations will be apparent to a person skilled in the art.

Once the job applicants have been selected for the following interview stage, they are provided with a user personal identification number (PIN) and password for identifying themselves. They are further provided with a telephone number that they may call to proceed with the second phase of the interviewing stage. Optionally, the users may further be provided with a time window during which to call the provided telephone number. In the present embodiment, The telephone number is a toll free number such as a 1-800 or 1-888 telephone number (in North America). A plurality of possible second interview stages includes behavioural profiling, external competency and skill testing, reference/credit checks and the like. In the present embodiment, the second interview is used for providing further employment-related questions.

Once the job applicant calls the toll free number, he/she is prompted to enter his/her PIN and password. The server verifies the PIN and password and retrieves the questionnaire completed by the job applicant over the Internet. The questions asked of the job applicant can be grouped in two categories. A first category includes standard questions that are asked of all the job applicants. A second category includes questions that are asked of each job applicant depending of the PIN number entered. For the second category, the server uses the results of the retrieved questionnaire responses for selecting some of a plurality of questions available. For example, if a job applicant that has indicated on the Internet questionnaire that he/she is fluent in French, the system retrieves a question, presents it to the job applicant in French, and prompts the job applicant to respond in French. Other questions, such as position and location dependent questions, may be included in this category.

All of the questions are predefined and provided by the employer. The employer typically chooses from predefined questions provided by a service provider that is contracted for implementing the automated interview. Herein, the service provider and employer are commonly referred to as the employer, unless otherwise specified. Unique questions specific to an individual interview are also included and can be included by the service provider or the employer. A recorder is a person associated with the employer who is responsible for connecting to the server and recording questions to be asked of the job applicant. The questions are entered into the system via a question recording sub system accessed through a hidden maintenance menu. Depending on the project, the hidden maintenance menu can be accessed through either the publicised telephone number or through a separate telephone line. The recorder enters a provided password. The password only allows the recorder to modify certain questions in a single interview. This prevents the accidental recording of wrong questions. The question recording sub system logs appropriate information when it allows recording of questions for a particular interview. Such information includes the identification of the caller, the password entered, which questions were recorded, and the times they were recorded. This allows the employer to quickly ascertain whether all of the questions have been properly recorded. The project manager is able to copy messages from similar interviews in order to reduce recording time.

The questions provided by the recorder and asked by the system may take various formats. For example, the system may ask questions that are multiple choice and therefore can be answered by pressing a button on the keypad of the telephone such as the numbers 1, 2, 3 and the like. The questions may also require the applicant to enter a numerical result which, again, may be entered using the keypad. The system may further prompt the user to respond verbally to a question, after which the system records the applicant's voice response for a later review by the employer, as exemplified below.

Since the system uses recognition of telephone keypad strokes as part of its input, the system is designed to recognize the numerals 1 to 10. The system is also capable of recognising the voice responses to multiple choice type questions. Such voice responses include key words such as “yes”, “no”, “poor”, “fair”, “good”, “very good”, “excellent” and the like.

Further, since the system has the ability for the job applicant to speak an answer to a question and to have the system record that response, the system allows for adjustable lime limits for the voice responses. The system further allows limits on the number of times an applicant repeats a particular question. The job applicants may also pause the system and resume the interview at the same position. Predetermined, but adjustable, limits are set the employer. System functionality such as repeats and pauses can also be customized on a question by question basis. Once the voice has been recorded, leading and trailing silences are clipped. This reduces unnecessary storage space. If no response is recorded or the response was inaudible to the system, the applicant is prompted to record the answer again.

A program manager is associated with the employer and develops the questionnaire flow. A logic editor is provided to the employer so that a questionnaire design is directly input into the server. The program manager also creates variables, which can be modified by the results of the question and referenced in a logic flow. The questionnaire can be created by starting with one question and building up a series of questions, or by creating questions based on a template. Several templates are provided on the system for each of the program managers. The program managers are able to create their own templates as well as modify and save the modified templates.

In a manner similar to the Internet based interview, the employer can define a weighting function to be associated with the IVR questionnaire. The weighting function is applied in a similar fashion as previously described for reducing the number of job applicant interviews that the employer has to review. Preferably, the employer only has to review the interviews of those job applicants whose weighted scores exceeds a threshold, is in a predetermined range, or a combination of the two. Weighting can also be applied in real-time in order to filter out applicants who will not meet the predetermined threshold thereby reducing interview length.

Once the job applicants have responded to the questionnaire, and the weighting function has been applied, the employer is able to review the applicant's responses to the voice recognition system by two possible methods. The system alerts the employer when an applicant is responding to one of the voice recognition questionnaires. At this point, the employer can use a telephone to connect with the server and listen in on the applicant's responses. Alternately, the employer can listen to responses in a digital format on a media provided by the service provider. Additionally, all of the applicants' responses are stored in a database to which the employer has access. Therefore, the employer can access each of the applicant's responses at his/her leisure. Furthermore, the employer can listen to an applicant's response more than once. The details of how the voice recognition system and server work are described in detail below.

The employer has remote access to the system. Such access includes starting, stopping, creating and modifying existing interviews, templates and questions. The employer can also view the results in the database and generate reports based on these results. The interviews can be amended without having to shut the system down. Therefore, a seamless restarting of a modified interview is supported. Also, the system makes random, automated system checks for ensuring that all ports and nodes are operating. Such system checks are also available on demand by the employer.

The system is able to handle a plurality of concurrent applications in a multi-node environment. In such an environment the interview that is being conducted is identified by the port and machine on which it is running, which facilitates line management and quality control. The system alarms the employer and the system administrator if it reaches 80% of its capacity (either ports or disk space). Such alarms utilise digital paging methods and are known in the art.

It is preferable that the system is available to job applicants seven days a week, twenty-four hours a day. Therefore, job applicant can “attend” the interview at their convenience, which is useful if the job applicant is already employed and looking to changes jobs.

As previously mentioned, all of the questionnaires and interview results are stored in a database. The information stored on this database is backed up typically in two methods. The first method is a daily backup of all the currently active interviews in the event of a system failure. The second backup system is the ability to offload an interview and its associated database tables when the interviewing phase is complete and all reports have been issued. Once the interview and its database tables are offloaded in this fashion, the employer can have the system operator copy the data onto a storage medium, such as a compact disc (CD), and issue a command to have the system reload the interview and the database tables.

A digital audio production system provides digital and CD production for voice recorded question results. The digital audio is typically accessed within hours of a live system ending. These digital and audio recordings are then saved by the employer for later review. Further, the project manager has the ability to generate a structured query language (SQL) query that selects a subset of user calls or a subset of interview questions from the database. This query is used to copy information on a storage medium, based on questions matching criteria determined on an ad hoc basis.

The term “employer” has been used generically throughout the description. This term is not meant to limit the description to only the hiring company itself, but includes people working for the company, such as service providers who may have been contracted to implement the automated interview. Another example is the recorder, who may be hired for the sole purpose of recording the questions. Since there may be a variety of different people accessing the system, it is preferable to have a various levels of security established.

Passwords are provided for each level of access such that appropriate security is provided to the system. A first level of security allows the employer the ability to listen to the voice responses. A second level of security allows the recorder to record voice prompts and review them. These voice prompts make up the questionnaire. A third level of security allows the project manager to create interview templates and logic flows for such templates. A forth level of security allows an administrator to have complete access to all capabilities of the system. Such capabilities include the ability to transfer ownership of an interview from one project manager to another, start, stop and “busy out” any interview or ports, and directly modify live data to remove obscene recordings and the like.

A fax back subsystem exists so that the employer can call up the system and request responses from a particular interview or a summary of the interview. Therefore, the spoken responses by the applicants can be converted to text format via manual data entry or voice recognition software. The fax back system then arranges the text information in a predetermined format and prepares to send a fax to the employer.

Further, the system includes a recording system that allows data collected from the interviews to be reported to the employers as requested. The system has the ability to send the information to the employer by electronic methods such as email. Therefore, the transmission may include a copy of the voice recording by the applicant. Alternately, as is the case with the fax back system, the emil may include a text version of the audio recording by the applicant.

In an alternate embodiment, the initial Internet based interview is replaced by another IVR interview. This embodiment is particularly useful for users who do not have Internet access readily available. The additional IVR interview performs the same function as the Internet based interview acting as a screening mechanism. Similarly to the Internet based interview, the job applicant is provided with a set of questions to answer, and is prompted for personal information. The job applicant answers the questions by selecting a button on a telephone keypad or by providing a spoken response. The questions are weighted and a score is determined as previously described the system further determines whether or not a second interview is desired based on the score of the interview and provides the job applicant with a PIN and a telephone number to call for the second interview. If desired by the employer, the system can determine whether or not a second interview is desired in real-time and seamlessly transfer the applicant into the second interview within the same call.

The telephone number provided to the job applicant may be the same number used for the first IVR interview or it may be a different telephone number. If the telephone number for both the first and the second interviews are the same, the IVR interview is capable of distinguishing between the first and second interviews. Typically this is done upon establishment of the telephone connection by providing the job applicant with an option for selecting either a first or second interview. If the job applicant selects the second interview, the system will require the PIN before proceeding. Therefore, it is unlikely that a job applicant will be able to proceed to the second interview without completing the first interview. For further security, the system may ask for other information from the job applicant, such name, address, password and the like, as well as the PIN. The other features of the system in the present embodiment are similar to those described in the previous embodiment.

In yet an alternate embodiment, the IVR of the previous embodiments is set up by the employer via the Internet. The employer navigates to a secure web site and logs on using a PIN or password, or both. In accordance with the log on information, the employer is provided with an extensive list of questions that can be asked of the applicant. The list includes questions that are to be answered using the keypad of the telephone as well as questions that are to be answered by voice response. The employer is further given the opportunity to add questions not present in the extensive list of questions. The employer selects the language (or languages) in which to present the questions and submits the questionnaire.

The IVR is conducted as described in the previous embodiments, and the employer is given an opportunity to review the responses provided by the applicant. The data is presented to the employer in a plurality of manners. For the present example, the employer accesses the applicant's responses by logging on to the secure web site. Alternately, the responses may be provided to the employer on a CD or other means as defined in the previous embodiments. The voice responses are played for the employer from audio files. The numerical responses are preferably presented visually, but may be presented aurally. The employer reviews the responses by listening to all the responses of one candidate, listening to how each candidate responded to one question, or a combination of the two. While the above has been described with reference to establishing an IVR interview, a person skilled in the art will appreciate how it applies to establishing an on-line interview.

Although the previous embodiments describe a system for providing employers with an automated interview for potential job candidates, the system need not only be used for job interviews. In yet an alternate embodiment, the system provides a user, such as a company, with an opportunity to provide an automated survey tool for projects such as customer satisfaction survey. The company has customer support representatives for assisting customers over the telephone with any difficulties or questions they may have. Presently, the company may monitor telephone calls between the customer and the customer support representatives for ensuring that adequate customer support quality is maintained.

This method for monitoring the customer support quality in not adequate for many reasons. The customer may be satisfied with the particular customer support representative on the line, but displeased with other aspects of the company. Furthermore, the person monitoring the phone call is open left to guess how the customer feels unless the customer is particularly vocal with his/her opinion. Therefore, the phone call will not necessarily reveal all the customer's criticisms or compliments.

In the present embodiment, each of the customer-support representatives is provided with a PIN for uniquely identifying him/her. At the end of a predetermined number of customer phone calls, the customer-support representatives asks the customer whether he/she would be interested in completing a customer satisfaction survey. If the customer declines the request, the call is terminated as usual.

If, however, the customer is interested in completing the survey, the customer-support representative uses his/her PIN for connecting the customer to the IVR system. One way for achieving this connection is the customer support representative connecting to the IVR system, entering his/her PIN number, and then connecting the client to the IVR system. Alternately, the system may be set up to automatically send the PIN when the customer support representative connects the customer to the IVR system, as will be appreciated by a person skilled in the art.

In the present embodiment, the IVR interview is similar to the second interview in the previous embodiments. The survey asked of the customer can be considered to comprise two sets. A first set includes standard customer satisfaction questions that will be asked of all customers completing the survey. A second set includes questions that are asked of the customer depending on which customer-support representative he/she spoke with

The second set of question is determined in accordance with the PIN number of the customer-support representative. The questions include questions about the particular service provided by the customer service representative. For example, if the service provided was technical assistance, then there may be questions regarding the customer service representative's knowledge level of the subject matter, his/her ability to explain the solution, and the like. Questions may also pertain to a particular line or product that is only being serviced by the particular customer support representative. The questions may further relate to regional information, also derived from the PIN, thereby allowing the company to focus on regional issues. The PIN entered may also be used at a later date for its regional information for grouping the customer satisfaction surveys so the company can look for regional trends.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A system for providing a secondary user with an interview, said system comprising:
(a) a questionnaire provided by a primary user, said questionnaire including a plurality of questions;
(b) a predefined weighting faction associated with said questions;
(c) a server operatively coupled with said secondary user, said server for providing said questionnaire to said secondary user for performing said interview;
(d) memory associated with said server for storing results of said interview; and
(e) a processor associated with said server for applying said predefined weighting function to said results of said interview for calculating a secondary user score, wherein if said secondary user score meets predefined criteria said secondary user proceeds to a second interview stage.

2. A system as defined in claim 1 wherein said secondary user is provided with a personal identification number (PIN) before proceeding to said second interview stage, said PIN for identifying said secondary user.

3. A system as defined in claim 2 wherein said second interview stage includes a further plurality of questions comprising a first and a second set, said first set including questions to be asked of a plurality of said secondary users and said second set including questions to be asked of said secondary user in accordance with said PIN.

4. A system as defined in claim 3 wherein said processor selects ones of said plurality of questions in accordance with said PIN, wherein said selected questions are associated with said secondary user.

5. A system as defined in claim 4, wherein said questionnaire is provided to said secondary users via a computer network.

6. A system as defined in claim 5, wherein said computer network is the Internet.

7. A system as defined in claim 4, wherein said questionnaire is provided to said secondary users via a telephone network.

8. A system as defined in claim 4, wherein said PIN is provided to said secondary user for later use by said secondary user.

9. A system as defined in claim 8, wherein said secondary user utilises said PIN for identification upon establishing a connection with said second interview stage.

10. A system as defined in claim 4, wherein said system seamlessly establishes a connection between said secondary user and said second interview stage in real time.

11. A system as defined in claim 4, wherein said memory comprises a database for storing and managing said results of said interview.

12. A system as defined in claim 11 wherein said database provides report generation.

13. A system as defined in claim 12, wherein said report generation comprises preparing said report and transmitting said report via facsimile.

14. A system as defined in claim 12, wherein said report generation comprises preparing said report and transmitting said report via a digital storage medium.

15. A system as defined in claim 14, wherein said digital medium comprises e-mail, magnetic storage devices, and optical storage devices.

16. A system as defined in claim 11, wherein said database provides structured query language (SQL) searches.

17. A system for providing a tertiary user with an interview, said system comprising:
(a) a questionnaire provided by a primary user, said questionnaire including a plurality of questions;
(b) a personal identification number (PINs) associated with a secondary user, said PIN for identifying said secondary user;
(c) a server operatively coupled with said secondary user, said server for providing said questionnaire for performing said interview, wherein said tertiary user is connected with said interview via said secondary user;
(d) memory associated with said server for storing results of said interview; and
(e) a processor associated with said server for selecting ones of said plurality of questions in accordance with said PIN, wherein said selected questions are associated with said secondary user.

18. A system as defined in claim 17, wherein said memory comprises a database for storing and managing said results of said interview.

19. A system as defined in claim 18, wherein said database provides report generation.

20. A system as defined in claim 19, wherein said report generation comprises preparing said report and transmitting said report via facsimile.

21. A system as defined in claim 19, wherein said report generation comprises preparing said report and transmitting said report via a digital storage medium.

22. A system as defined in claim 21, wherein said digital medium comprises e-mail, magnetic storage devices, and optical storage devices.

23. A system as defined in claim 18, wherein said database provides structured query language (SQL) searches.

24. A system as defined in claim 17, wherein said questions further include questions provided to said tertiary users regardless of said PIN.

25. A system as defined in claim 17, wherein said primary user is a company or employee thereof, said secondary user is a customer support representative and said tertiary user is a client.

26. A method for interviewing a secondary user, said method comprising the steps of:
(a) providing a questionnaire from a primary user, said questionnaire including a plurality of questions;
(b) recording a response from said secondary user;
(c) applying a predefined weighting function associated with said plurality of questions;
(d) automatically calculating a secondary user score in accordance with said predefined weighting function, wherein if said secondary user score meets predefined criteria said secondary user proceeds to a second interview stage.

27. An on-line method for setting up an automated interview comprising the steps of:
(a) logging on to a predefined web site;
(b) selecting a set of interview questions to be asked of a potential interviewer from a predefined list of questions; and
(c) submitting said selected set of interview questions to a questionnaire creator for generating said automated interview.

28. A method as defined in claim 27, including the additional steps of creating and submitting a customized question.

29. A method as defined in claim 28, wherein said questions are capable of being posed in a plurality of different languages in accordance with predefined criteria.

30. A method as defined in claim 29, wherein said automated interview is conducted via a telephone using interactive voice response.

31. A method as defined in claim 29, wherein said automated interview is conducted via a computer using the Internet.
